(19) United States
(12) Patent Application Publication
(10) Pub. No.: US 2012/0047630 A1
(43) Pub. Date: Mar. 1, 2012

(54) Detachable Decorative Items for Clothing and Clothing Accessories

(76) Inventor: Amy Gare, Weston, CT (US)

(21) Appl. No.: 12/891,978

(22) Filed: Sep. 28, 2010

Related U.S. Application Data
(60) Provisional application No. 61/376,381, filed on Aug. 24, 2010.

(51) Int. Cl. A41D 27/08; A44B 1/00; A44B 17/00; A44B 18/00; H01F 7/00

(52) U.S. Cl. 2/244; 24/3.1

(57) ABSTRACT

According to some embodiments, a clothing item has embedded thereon a plurality of attachment portions. For example, a child's jean skirt may be provided with a number of different metallic snaps. Moreover, a plurality of decorative items may be provided. Each decorative item may have, for example, an attachment portion adapted to be removably attached to an attachment portion of the clothing item.

### CROSS REFERENCE TO RELATED APPLICATION

The present application claims priority under 35 U.S.C. §119(e) to U.S. Provisional Patent Application Ser. No. 61/376,381 entitled “DETACHABLE DECORATIVE ITEMS FOR CLOTHING AND CLOTHING ACCESSORIES” on Aug. 24, 2010. The entire content of that application is incorporated herein by reference.

### FIELD

The present invention relates to clothing and/or clothing accessories. In particular, some embodiments of the present invention are directed to detachable decorative items for clothing and/or clothing accessories.

### BACKGROUND

People like to wear clothing with various decorative items. For example, children may enjoy wearing jeans adorned with patches, jewels, and/or other decorative items. However, people often like to wear different decorative items at different times (e.g., due to change's in taste or because of other items of clothing that are being worn at the same time). Purchasing many different items of clothing to satisfy this desire can be a time consuming and expensive task. Moreover, people tend to enjoy expressing themselves in creative ways. Sewing decorative items onto clothing however, requires a considerable amount of skill and may be beyond the abilities of many children. Further, decorative items on children's clothes are generally difficult to launder and often become damaged or lost in the process.

### SUMMARY

To alleviate these problems, some embodiments of the present invention introduce detachable decorative items for clothing and/or clothing accessories. The decorative items may be removed and interchanged to allow for a variety of designs and greater ability to clean the clothes upon which the decorative items are attached.

### BRIEF DESCRIPTION OF THE DRAWINGS

FIG. 1 is system 100 according to some embodiments of the present invention.

FIG. 2 is a flow diagram illustrating a method of providing detachable decorative items for clothing and/or clothing accessories in accordance with some embodiments.

### DETAILED DESCRIPTION

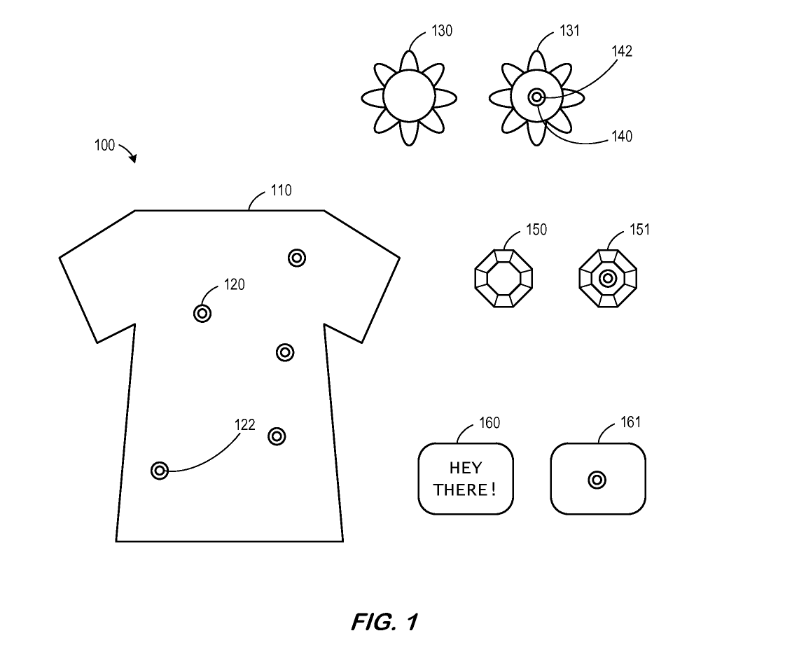

Referring now to the drawings, FIG. 1 is system 100 according to some embodiments of the present invention. The system 100 includes a clothing item 110 (a shirt as illustrated in FIG. 1). According to some embodiments, the clothing item might comprise clothes (e.g., a jean clothing item, a jacket, a shirt, a skirt, pants, or a dress) or any clothing accessory (e.g., a hat, a scarf, or a belt). The clothing item 110 has embedded thereon a plurality of attachment portions 120. The attachment portion 120 may further include, for example a metallic post or metallic post receiving element 122.

The system 100 further includes a plurality of decorative items 130, 140, 150. In particular, a front view of a floral item 130, a front view of a jewel item 150, and a front view of a patch item 160 are illustrated in FIG. 1. As illustrated by the back views of the decorative items 131, 141, 151, each item includes an attachment portion 140. The attachment portion 140 may further include, for example a metallic post or metallic post receiving element 142 adapted to be removable mated with a corresponding attachment portion 120 on the clothing item 110. That is, the attachment portions 120 embedded on the clothing item 110 might comprise male metallic snaps, in which case the attachment portion 140 on each decorative item 130, 150, 160 would comprise a female metallic snap. Alternately, the attachment portions 120 embedded on the clothing item 110 might comprise female metallic snaps, in which case the attachment portion 140 on each decorative item 130, 150, 160 would comprise a male metallic snap.

Thus, the system may enable people to wear different decorative items at different times and in different ways. Moreover, people may express themselves in creative ways in a cost efficient and relative low-skilled manner. Further, the garment may be laundered more easily after removing the decorative item.

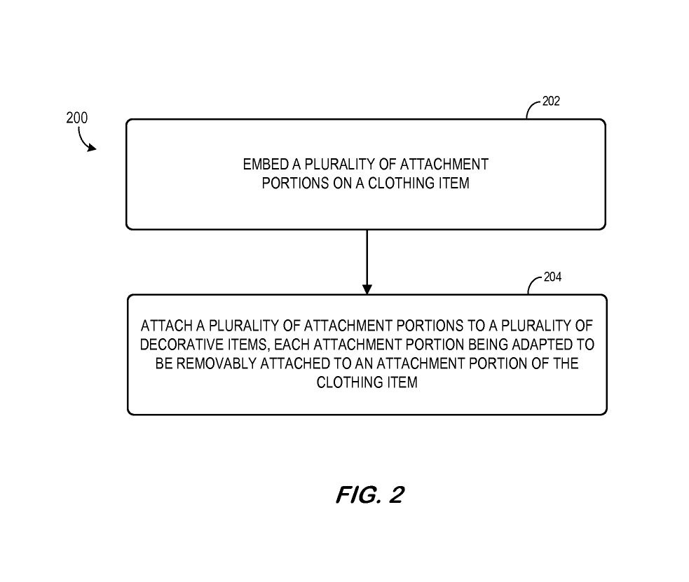

FIG. 2 is a flow diagram. The flow charts described herein do not imply a fixed order to the steps, and embodiments of the present invention may be practiced in any order that is practicable. At 202, a plurality of attachment portions are embedded onto a clothing item. The attachment portions might be embedded onto a clothing item in any number of ways, including, for example, by glue or other adhesive, sewing, press machines, etc. At 204, a plurality of attachment portions are attached to a plurality of decorative items, each attachment portion being adapted to be removably attached to an attachment portion of the clothing item. In this way, a user can change the appearance of the clothing item in a fun and cost efficient way.

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although embodiments of the present invention have been described with respect to clothing and decorative items, according to other embodiments similar attachment portions may be provided on other items. For example, a child's bed, doll, pillow, or blanket might include attachment portions to receive decorative items. Moreover, although metallic snaps have been described to attach decorative items to clothing items, note that any other means of removable attachment might be provided (e.g., a Velcro portion®, a magnetic portion, a plastic snap portion, or a button portion).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A clothing decoration system, comprising:
a clothing item having embedded thereon a plurality of attachment portions; and
a plurality of decorative items, each decorative item having an attachment portion adapted to be removably attached to an attachment portion of the clothing item.

2. The system of claim 1, wherein the clothing item comprises at least one of: (i) a jean clothing item, (ii) a jacket, (iii) a shirt, (iv) a skirt, (v) pants, (vi) a hat, (vii) a scarf;
(viii) a dress, or (ix) a belt.

3. The system of claim 1, wherein the attachment portions embedded on the clothing item comprise male metallic snaps and the attachment portion on each decorative item comprises a female metallic snap.

3. The system of claim 1, wherein the attachment portions embedded on the clothing item comprise female metallic snaps and the attachment portion on each decorative item comprises a male metallic snap.

4. The system of claim 1, wherein at least one of the decorative items comprise at least one of but not limited to the following: (i) a jewel, (ii) a patch, (iii) a floral decoration, (iv) a bow; (v) a button ; or (vi) a ribbon.

5. The system of claim 1, wherein at least one of the attachment portions is comprise at least on of: (i) a Velcro portion®, (ii) a magnetic portion, (iii) a plastic snap portion, (iv) a metal portion or (v) a button portion.

6. A clothing item decoration method, comprising:
embedding a plurality of attachment portions on a clothing item; and
attaching a plurality of attachment portions on a plurality of decorative items, each attachment portion being adapted to be removably attached to an attachment portion of the clothing item.
